(19) United States
(12) Patent Application Publication
(10) Pub. No.: US 2016/0104167 A1
(43) Pub. Date: Apr. 14, 2016

(54) DEVICE AND METHOD FOR POPULATING A LEGAL FILING WITH AN INDIVIDUAL'S NAME FROM A GOVERNMENT-ISSUED IDENTIFICATION DOCUMENT

(71) Applicant: C T CORPORATION SYSTEM, New York, NY (US)

(72) Inventors: Richard D. Vanko, Pearland, TX (US); Ian Campbell, McKinney, TX (US); Shawn Kastle, Stevensville, MD (US)

(73) Assignee: C T CORPORATION SYSTEM, New York, NY (US)

(21) Appl. No.: 14/511,056

(22) Filed: Oct. 9, 2014

(51) Int. Cl. G06Q 30/00; G06K 7/10

(52) U.S. Cl. CPC G06Q 30/018; G06Q 40/025; G06K 7/10821

(57) ABSTRACT

A device and method for populating a legal filing with an individual's name exactly as it appears on a government-issued identification document. The individual's name is read using a symbolic barcode on the government-issued identification document without storing, or even reading, other information contained in the symbolic bar code that may contravene applicable laws or regulations relating to the storage of such information. The individual's name exactly as it appears on the government-issued identification document is used to populate a legal filing document.

### FIELD OF THE INVENTION

The present invention relates to the field of legal compliance, and, in particular, to the preparation of legal documents for filing with a recordation entity. More particularly, the invention relates to a device and method for decoding a barcode on an individual debtor's government-issued identification document to retrieve that individual debtor's name exactly as it appears on the government-issued identification document, and populating a legal filing using the retrieved individual debtor's name. The invention may, for example, be used to retrieve at least a debtor's name from a government-issued identification document, typically a driver's license, and populate a filing, such as a financing statement pursuant to Revised Article 9 of the Uniform Commercial Code for perfecting a creditor's security interest in the debtor's personal property or fixtures, with the debtor's name exactly as it appears on the government-issued identification document without storing, or even reading, other information relating to the debtor as printed on the government-issued identification document that is prohibited or discouraged by law or regulation.

### BACKGROUND OF THE INVENTION

It is often necessary to prepare a legal filing containing an individual's name exactly as that individual's name appears on a government-issued identification document. One example is perfecting a security interest under Revised Article 9 of the Uniform Commercial Code (“the UCC”) in jurisdictions that have adopted the UCC as law. The UCC Revised Article 9 deals with secured transactions where a creditor takes a security interest in a debtor's personal property or fixtures by recording that interest with a designated government agency, such as a Secretary of State's office. To properly perfect the security interest, the creditor must file a financing statement or equivalent document in the designated filing office that complies with certain requirements enumerated in §9-501 et seq. of the UCC. One of these requirements, §9-503, imposes restrictions on the name of the debtor as it appears on the financing statement: if the debtor is an individual to whom the State has issued a driver's license that has not expired, then the financing statement must provide the name of the individual exactly as it is indicated on the driver's license. If the financing statement does not reproduce the debtor's name exactly as it appears on the State-issued driver's license, then the creditor's security interest will not be properly perfected under the UCC, and the creditor may lose its secured status. This requirement presents difficulties for creditors as debtors often use alternate spellings of their names, may use a middle initial on some documents but not others, may use one an aliases, or may have changed their names after receiving a driver's license but before completing a secured financing agreement.

Obtaining an individual debtor's name as it appears on his/her State-issued driver's license, however, presents potential problems in view of other legal requirements typically present in UCC jurisdictions. For example, the Fair Credit Reporting Act (“the FCRA”), the Equal Credit Opportunity Act (“the ECOA”), and the Fair Debt Collection Practices Act (“the FDCPA”) provide legal regulations on the collection and retention of personal information that is usually contained on a State-issued driver's license. Regulation B of the ECOA, codified at 12 C.F.R. §202 et seq., prohibits unlawful discrimination against an individual in a credit transaction based on certain characteristics of the borrower or applicant for financing. To this end, 12 C.F.R. §202.5(b) prohibits a creditor from inquiring about the race, color, religion, national origin, or gender of an applicant or any other person in connection with a credit transaction other than for purposes of testing compliance with the ECOA. Storing a photocopy or digital reproduction of a driver's license may also contravene one or more of the applicable statutes. Therefore many creditors, in order to ensure they are in compliance, are not retaining any information that may be prohibited or discouraged pursuant to these statutes and regulations. Such information that is not retained is referred to herein as detrimental data.

### SUMMARY OF THE INVENTION

A computer implemented method for validating individual debtor information to perfect a creditor's security interest including receiving, by an electronic circuit, an image of an individual debtor's government-issued identification document, wherein the image contains at least one bar code, decoding the at least one bar code, by anelectronic circuit, to retrieve information about the individual debtor from the at least one bar code, said information including at least a first name and a surname for the individual debtor, stripping from said information about the individual debtor fields that represent detrimental data; storing the first name and the surname for the individual debtor in an electronic storage medium, obtaining a security interest form from a source location, said security interest form having at least fields for the first name and the surname of the individual debtor, and populating the first name and surname fields of the security interest form with the individual debtor's first name and surname.

In another embodiment, a computer system for validating individual debtor information to perfect a creditor's security interest includes a communications network interface, one or more computer processors, one or more memories coupled to the one or more processors, wherein the one or more memories include computer executable instructions stored thereon that, when executed by the one or more processors, cause the one or more processors to: receive an image of an individual debtor's government-issued identification document, where the image contains at least one bar code, decode the at least one bar code to retrieve information about the individual debtor from the at least one bar code, said information including at least a first name and a surname for the individual debtor, store the first name and the surname for the individual debtor in an electronic storage medium, obtain a security interest form from a source location, said security interest form having at least fields for the first name and the surname of the individual debtor, and populate the first name and surname fields of the security interest form with the individual debtor's first name and surname.

### BRIEF DESCRIPTION OF THE DRAWINGS

The figures described below depict various aspects of the system and methods disclosed herein.

FIG. 1 is a diagram of the organization and entity relationships among creditor, debtor, government filing agency, and department of motor vehicles in an embodiment of the invention.

FIG. 2 is a diagram of an example debtor information validation system, according to one embodiment.

FIGS. 3A and 3B illustrate the front and back of an example of a government issued identification document.

FIG. 4 is an illustration of a network-enabled device for use with the debtor information validation system.

FIG. 5A is a flow diagram illustrating a method for validating individual debtor information to perfect a creditor's security interest.

FIG. 5B is a flow diagram illustrating a method for scanning and decoding a bar code in accordance with the present invention.

FIG. 6 illustrates a user login screen.

FIG. 7 illustrates a home page screen.

FIG. 8 illustrates an identification document-scanning screen.

FIG. 9 illustrates a successful scan screen.

FIG. 10 illustrates an individual debtor identification document information table.

FIGS. 11A and 11B illustrate debtor information selection screen and financing statement population screen, respectively.

### DETAILED DESCRIPTION OF THE PREFERRED EMBODIMENTS

This disclosure refers throughout to the use of a government-issued identification document as a driver's license. This is not meant to limit the invention to an embodiment with a driver's license per se, but rather includes any type of document, whether it is a government-issued identification document such as a passport, visa, identification card, etc., or it could also refer to other government-issued documents, containing identity information that may be collected and used to populate a form, filing, or other type of legal document such as past known address records, property records, or public records documents. The term driver's license is only meant to illustrate an embodiment where the government-issued document is an identification document that is a driver's license. Similarly, this disclosure uses a financing statement as only an example of a legal document populated with information collected from a government-issued identification document, but persons of ordinary skill in the art will understand that any governmental or non-governmental legal document may be populated using the systems and techniques of the present invention such as credit applications, liens, assignment documents, records of real property transfer, oaths or affirmations, etc. The present invention may also be used for purposes other than populating a document or filing, such as for verification of information or for compliance purposes. As used herein, the term name may refer to a first name and/or surname, as well as any other components of a name that appear on the government-issued identification documents including middle name, middle initial, first initial, prefix (e.g., Dr., Mr., Mrs., Prof., Capt., Amb., Gov., Sen., etc.), and/or suffix (e.g., Jr., III, Esq., M.D., etc.).

In view of the present regulatory environment and revised provisions of the UCC as adopted by most jurisdictions, secured creditors seek a reliable way to prepare financing statements or other legal papers necessary to properly perfect security interests without running afoul of various consumer protection and privacy laws. There may be a legal requirement in the relevant jurisdiction that the debtor's name appear on the filed financing statement exactly as it appears on a government identification document, such as a state-issued driver's license. Secured creditors do not, however, simply photocopy or scan an image of a debtor's driver's license because of additional privacy and consumer protection-related legal restrictions. Instead, creditors need a way to collect selected information from a driver's license without storing a copy of the document or storing any information about the applicant included thereon that is prohibited or discouraged by law, regulation, or generally accepted practice in the processing of loan or banking activities, e.g., “detrimental data” such as race, gender, able-bodied status, age, national origin, sexual orientation, religion, criminal history, social security number, etc.

The present invention teaches techniques for decoding a debtor's name from a symbolic barcode on a driver's license, and using it to populate a financing statement to be filed with a designated government agency to perfect a creditor's security interest in the debtor's personal property or fixtures. Many state-issued driver's licenses contain one or more symbolic barcodes encoded with some or all of the information presented on the front and back faces of the document; potentially the barcode could contain information that is not printed on either face of the document.

One type of barcode frequently used in this way is the PDF417 barcode, a stacked linear barcode symbol format, developed by Symbol Technologies, Inc., represented by ISO standard 15438, and selected by the United States Department of Homeland Security as the machine-readable zone technology for “RealID” compliant driver's licenses and state issued identification cards. PDF417 is also commonly used for other applications such as the airline industry's Bar Coded Boarding Pass (BCBP) standard, as postage for the United States Postal Service and Federal Express package labels, and more. Other types of suitable symbolic bar codes known in the art include UPC-A, HIBC, Pharmacode, Aztec code, Data Matrix code, QR code, or others. Whatever the format of the barcode, it may be detected by an input device such as a laser scanner, a charge coupled device, a camera, an RS-232 barcode scanner, etc., to transfer input to an application program that applies the appropriate symbology to decode information stored therein. State-issued driver's licenses usually contain PDF417 barcodes encoding the information printed on the license including the exact spelling of the driver's license holder's name, but other barcode formats can also be used for this purpose.

Secured creditors could use a device and method to decode selected information from a debtor's state-issued driver's license such as to obtain the exact spelling of a debtor's name without storing, or even reading, information that is prohibited by law, regulation, or custom, and without storing an image or photocopy of the debtor's state-issued driver's license to avoid storing the detrimental data. The American Association of Motor Vehicle Administrators (AAMVA) has promulgated a standard naming convention for the fields contained on a driver's license such that each field has a predetermined name. It is possible, pursuant to the AAMVA naming convention, to store only the information in predetermined fields relating to the debtor's name without collecting information from any fields corresponding to detrimental data or any data that is not name data. Moreover, some jurisdictions may impose additional privacy requirements regarding address information or other information; it may therefore be desirable to make a jurisdiction-by-jurisdiction determination of which information fields to collect. The extracted debtor name information could be used to populate a financing statement or other type of legal form with the debtor's name as it appears on the license to be filed with a state agency to perfect the creditor's security interest in the debtor's personal property or fixtures. The creditor would therefore have assurance that no discrepancy occurred between the debtor's name as printed on the state-issued driver's license and the financing statement or other security interest form.

The debtor's name as printed on his/her driver's license may be collected via a barcode in any of a number of ways consistent with the present invention. Suitable devices for the collection and transmission of the debtor's name include handheld or personal devices such as cell phones, personal trackers, smart watches, smartphones or others. In an embodiment, the debtor uses a smartphone application to scan the barcode and transmit only the decoded name, and not other information, to a computing platform suitable for populating a legal filing with the decoded name. In another embodiment, the secured creditor requests access to the debtor's driver's license, and performs the scan before returning the driver's license to the debtor. In another embodiment, the driver's license barcode is procured directly from a state department of motor vehicles, such as by transmission over a public packet switched network, a fax transmission, a voicemail attachment, or any other type of known data transmission protocol. Once the barcode is received/stored by the bar code scan module and decoded by the data extraction module such that the debtor's name exactly as it appears on the driver's license is known, it would be possible to use the name to populate a financing statement or other legal document, and to file that document with the relevant government agency or authority.

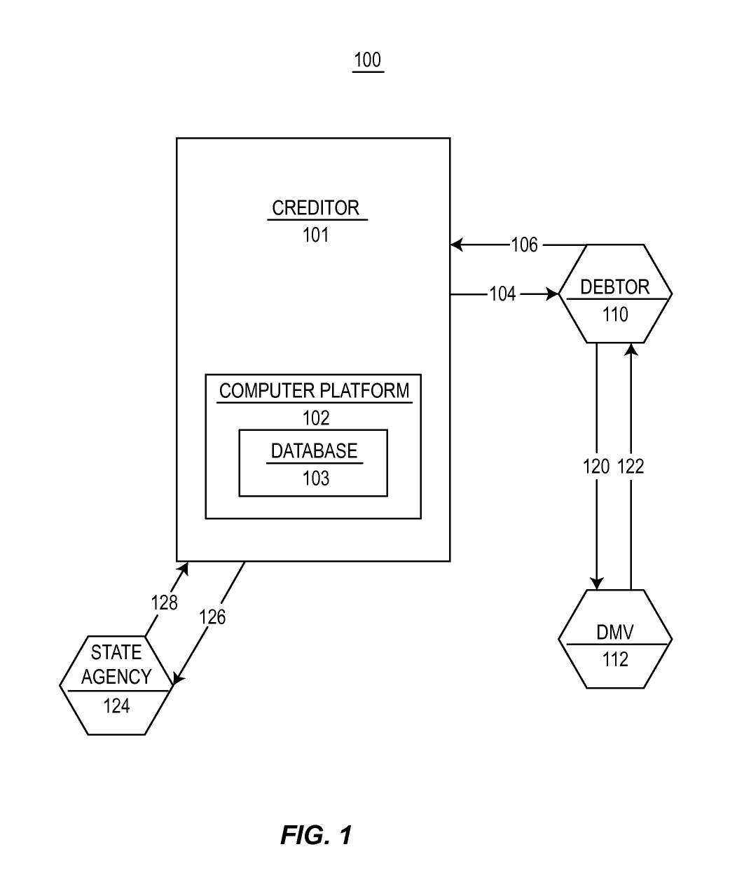

FIG. 1 is a diagram of an individual debtor identification environment 100, according to an embodiment of the invention. The embodiment of FIG. 1 includes a creditor 101, a debtor 110, a government identification document issuing office (e.g., department of motor vehicles (DMV)) 112, and a state agency 124. Creditor 101 provides secured loan products and/or services to entities including debtor 110. Creditor 101 or debtor 110 may include an entity or entities or one or more persons such as employees, partners, members, owners, directors, officers, shareholders, or other constituents of an organization. Creditor 101 or debtor 110 may be a legal entity, such as a partnership, corporation, sole proprietorship, or a limited liability company. In some cases, creditor 101 is a business or banking institution. Creditor 101 or debtor 110 may include one or more departments, divisions, entities, sectors, units, businesses, etc. In some embodiments, creditor 101 is a financing company.

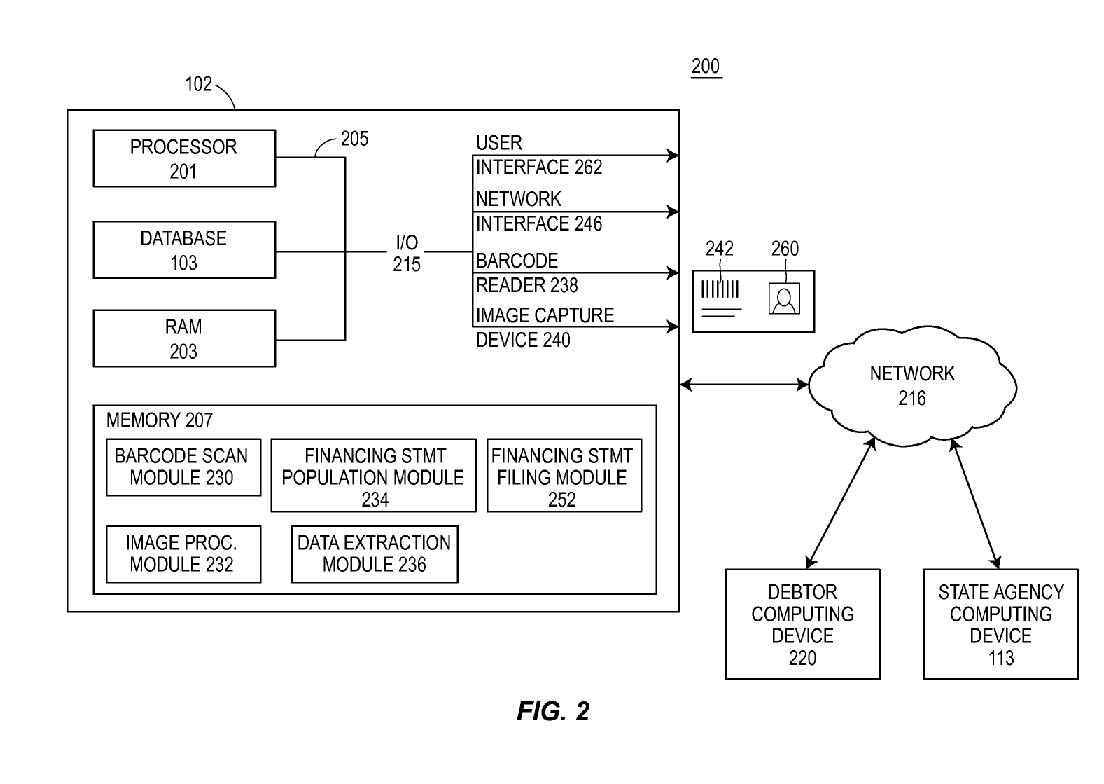

FIG. 1 indicates only the general relationship among the various entities shown. Computer platform 102 is also shown at a high level of abstraction. FIG. 2 supplies more detail on the structure of computer platform 102 and other elements of the present invention. In the embodiment of FIG. 1, the computer platform 102 is located at the physical location of the creditor 101. Alternatively, the computer platform 102 may be remotely located, that is, the computer platform 102 is not located at the physical location of the creditor 101. Computer platform 102 may be hosted by an entity other than creditor 101. In an embodiment, debtor 110 hosts computer platform 102. Computer platform 102 may further include a database 103. Database 103 may be used to store data received from one or more of debtors 110. In FIG. 1, the database 103 is located on the computer system 102, but, like computer system 102, database 103 could be located remotely.

Creditor 101 engages with debtor (104) to obtain information relating to its secured loan products and/or services. Debtor 110 responds to creditor (106) to supply responsive information in connection with these services. In FIG. 1, creditor 101 includes a computer platform 102 to facilitate informational engagement (104) with debtor 110. The computer platform 102 may be used to implement aspects of the invention disclosed herein. The computer platform 102 may receive, format, organize, store, process, modify, update, and/or analyze data about one or more debtors 110. One type of data requested by creditor 101 from debtor 110 may be for driver's barcode from a government identification document such as a driver's license. Creditor 101 may then use the computer system 102 populate a financing statement such as the debtor's name exactly as it appears on the government identification document or driver's license. In FIG. 1, debtors 110 may engage creditor 101 by requesting a secured loan. Alternatively, creditor 101 may contact the debtor 110 to collect required information to perfect a security interest in a loan. FIG. 2 provides additional details about the data exchange between creditor 101 and other entities such as debtor 110.

FIG. 1 also shows the debtor 110 communicating with department of motor vehicles 112. Debtor 110 may make a request (120) to department of motor vehicles 112 for a driver's license. The response (112) from department of motor vehicles 112 may be to issue a driver's license to debtor 110. Alternatively, the response (122) may be to decline to issue a driver's license. FIG. 1 also shows the creditor 101 communicating with state agency 124. State agency 124 may be the agency designated under a state's adoption of the UCC, a Secretary of State's office, or any other governmental agency authorized by law to accept financing statements to perfect a creditors security interest.

FIG. 2 is a block diagram of an implementation 200 of the present invention, according to an embodiment. FIG. 2 illustrates computer platform 102 shown in FIG. 1 in greater detail. Computer platform 102 may be, for example, a computer, a server, a plurality of networked computing devices having a logical appearance of a single computing device, a plurality of cloud computing devices, etc. Accordingly, for ease of discussion only and not for the purposes of limitation, computer platform 102 is referred to herein using the singular tense, although some embodiments of the invention may include more than one physical computing device. Computer platform 102 may include a memory 207, a processor 201 (which may be a controller, microcontroller, or a microprocessor), a random-access memory (RAM) 203, and an input/output (I/O) circuit 215, all of which may be interconnected via an address/data bus 205, a user interface 262, a network interface 246, a bar code reader 238, and a camera image capture device 240. The memory 207 may comprise one or more tangible, non-transitory computer-readable storage media or devices, and may be configured to store computer-readable instructions that, when executed by the processor 201, cause the computer platform 102 to implement the embodiment 200.

Memory 207 may store computer-readable instructions and organize them into modules that can be executed to implement the embodiment 200. In the displayed embodiment, memory 207 stores several computer program modules including barcode scan module 230, image processing module 232, financial statement preparation and population module 234, data filtering/extraction module 236, among others modules that may be implemented to carry out the invention. In some embodiments, the memory 207 may store different modules than those displayed, while in other embodiments, the memory 207 may store fewer or more modules than those displayed. In some embodiments, the executable computer-readable instructions may not be organized as modules. In some embodiments, instructions may be organized as routines, subroutines, or other blocks of information. Thus, the depiction of modules in FIG. 2 is at least in part for illustration.

Computer platform 102 may be operatively connected to send and receive communications, data, requests, and/or responses over the network 216 via I/O (input/output) circuit 215 and via network interface 246. The computer platform 102 may connect to the network 216 at the network interface 214 via a wired or wireless connection, or other suitable communications technology. The network 216 may be one or more private or public networks. The network 216 may be a proprietary network, a secure public internet, a virtual private network or some other type of network, such as dedicated access lines, circuit switched telephone lines, satellite links, a public packet switched network, or any combination of the above. Where the network 216 comprises the Internet, data communications may take place over the network 216 via an Internet communications protocol.

Barcode scan module 230 includes instructions executed by processor 201 to extract a debtor's name exactly as it appears on the debtor's driver's license. Barcode scan module 230 may begin by accessing symbolic barcode data 242 from barcode reader 238 or image capture device 240. Barcode reader 238 may be any known type of barcode reader such as an RS-232 device or any device with a lens, light sensor, and decoding circuitry for analyzing barcode data 242 and an output port to send the barcode's content to barcode scan module 232 via I/O circuit 215 to barcode scan module 230 on memory 207. Alternatively, barcode data 242 may be obtained via image capture device 240. Unlike barcode scan module 232, image capture device 240 may not contain decoding circuitry. Instead, image capture device 240 only creates a digital image of the sensed barcode. Whatever the means for obtaining the barcode data 242 it is sent to barcode scan module 230 via I/O circuit 215, or, in another embodiment, from another device via network 216 and network interface 246.

If barcode scan module 230 receives decoded barcode data, it may pass the data to data extraction module 236. Data extraction module 236 parses the input data, and extracts the portions thereof needed to complete the filing, while filtering and thus preventing even temporary storage of detrimental data that can cause the creditor to run afoul of privacy and/or consumer protection regulations and laws. In the embodiment of FIG. 1, the extracted data includes the individual's name exactly as it appears on a driver's license containing bar code data 242. If barcode scan module 230 receives an image of barcode data 242, it then calls image-processing module 232. Image processing module 232 applies software algorithms equivalent to the hardware decoding circuitry in bar code reader 238 to provide barcode data to return to barcode scan module 230. Image processing module 232 may also include instructions executed by processor 201 to examine scanability and quality of the image of a barcode in comparison to the specification for the type of barcode data intended for input into the system. Image processing module 232 may perform tasks including barcode verification and noise reduction. If the input bar code data 242 fails scanability or quality tests, image processing module 232 may return an error code to bar code scan module 230.

After this, financing statement population module 234 is sent the extracted bar code data by bar code scan module 230. Financing statement population module 234 retrieves a financing statement form from database 250 and populates the appropriate fields with the extracted bar code data. In the embodiment of FIG. 1, financing statement population module populates the financing statement with the debtor's name exactly as it appears on the debtor's driver's license.

Alternatively, computer platform 102 may receive barcode data 242 from one or more debtor computing devices 220 via the network 216 according to any of a number of known network protocols such as, for example, an Internet protocol. Computer platform may request bar code data from debtor computing device 220 or DMV 112 or it may accept data in a transmission initiated by debtor computing device 220 or DMV 112.

In some embodiments, an agent, employee, or representative of creditor 101 may receive the barcode data directly from a debtor via an e-mail, SMS message, web communication, cloud upload, or other method of digital communications. The agent of creditor 101 may then transmit barcode data 242 to computing platform 102 over network 216 via user interface 262 or via an organizational or personal computing device (not shown in FIG. 2).

The database 103 may be configured or adapted to store data related to bar code data 242; specifically, database 103 may be adapted to store data that is not detrimental data. Database 103 may be used to store various data including personal data, credit data, address data, loan performance data, loan data relating to the secured piece of personal property, underwriting data, insurance data, and other data relevant to perfecting the security interest. Database 103 may be located physically at creditor 101 or remotely therefrom. Database 103 may be split into constituent parts wherein some parts are located at creditor 101 and other parts are located remotely. Although only one processor 201 is shown in FIG. 2, computing platform 102 may include multiple processors 201. Although the I/O circuit 215 is shown as a single block, the I/O circuit may include a number of different types of I/O circuits. Similarly, the memory 207 of computing platform 102 may include multiple RAMs 203 and multiple program memories 207. The instructions and modules stored thereon may additionally or alternatively be stored in the RAM 203 or other local memory (not shown). The RAMs 203 and program memories 207 may be implemented as semiconductor memories, magnetically readable memories, chemically or biologically readable memories, and/or optically readable memories or may utilize any suitable memory technology.

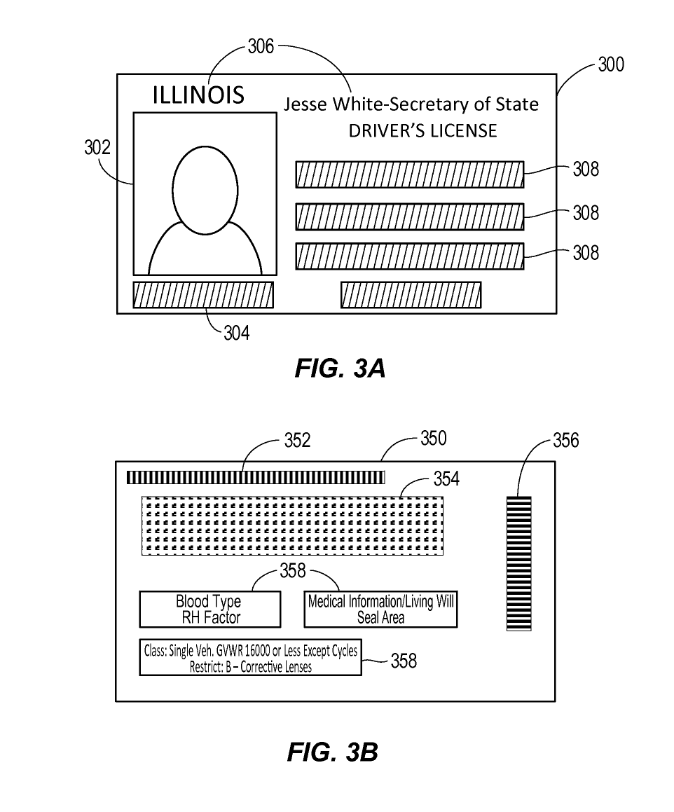

Turning now to FIGS. 3A and 3B, there is illustrated a front and back of an example government-issued identification document, respectively. Front 300 of government-issued identification document contains information including the debtors photo 302, signature 304, name of issuing government agency or agencies 306, and personal information fields 308. Personal information fields 308 include information such as the debtor's license number, date of birth, expiration date, issue date, home address, license class, restrictions, type, gender, height, weight, eye color, organ donor status, and more. Back 350 of government-issued identification document contains license information 358 such blood type, RH factor, medical information, living will seal, license class, license restrictions, and more. Back 350 of government-issued identification document also contains a first bar code 352, a second bar code 354, and a third bar code 356. Other embodiments may contain more or fewer bar codes. Bar codes 352, 354, and 365 may be of different types or of the same type of bar code. Some or all of these bar codes may be encoded with information such as signature 304, issuing agency or agencies 306, personal information 308 such as, license information 358, or other additional information not expressly illustrated in FIGS. 3A and 3B. Bar codes 352, 354, and 356 may be of any type known in the art such as, for example, a PDF417 format bar code.

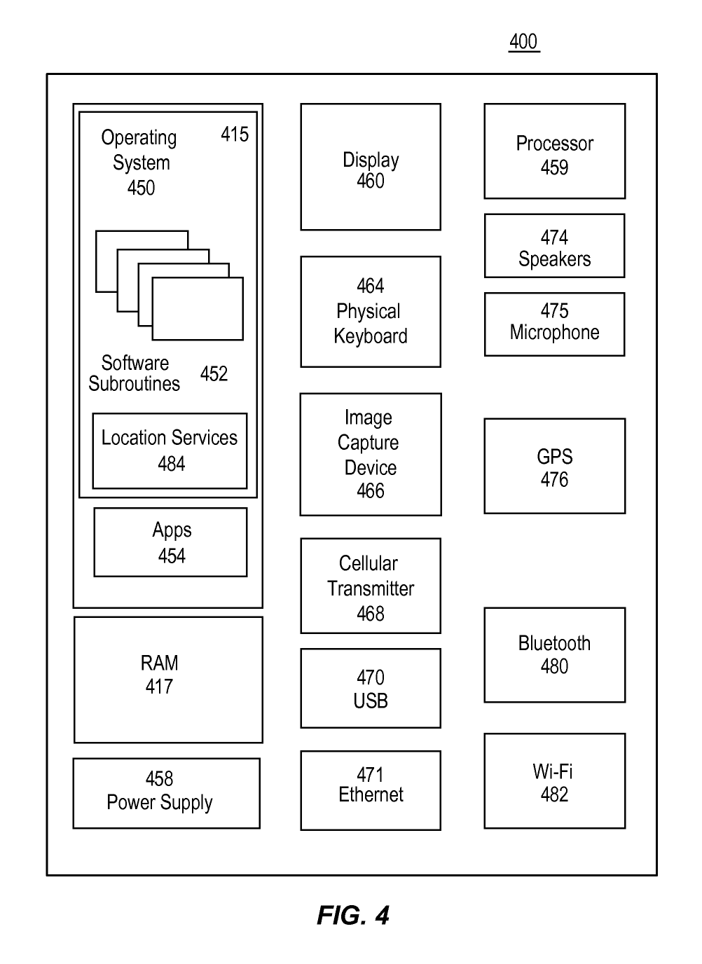

FIG. 4 depicts a block diagram of an exemplary debtor computing device 220 or state agency computing device 113, for example, a smart phone 400. The device 400 may operate in a variety of hardware and/or software configurations. The device 400 includes a controller (not shown). Similar to the controllers described above, the controller includes a program memory 415, a microcontroller or a microprocessor 459, a random-access memory (RAM) 417, and an input/output (I/O) circuit (not shown), all of which are interconnected via an address/data bus (not shown). In some embodiments, the controller may also include, or otherwise be communicatively connected to, a database (not shown) or other data storage mechanism (e.g., one or more hard disk drives, optical storage drives, solid state storage devices, SIM cards, etc.). It should be appreciated that although FIG. 4 depicts only one microprocessor 459, the controller may include multiple microprocessors 459. Similarly, the memory of the controller may include multiple RAMs 417 and multiple program memories 415. The controller may implement the RAM(s) 417 and the program memories 415 as semiconductor memories, magnetically readable memories, and/or optically readable memories, for example.

The program memory 415 and/or the RAM 417 may store various applications (i.e., machine readable instructions) for execution by the microprocessor 459. For example, an operating system 450 may generally control the operation of the device 400 and provide a user interface to the device 400. Various applications 454 may allow the user to perform various functions associated with the device 400. By way of example, and without limitation, the applications 454 may include, among other things: an application for accessing telephony services; an application for sending and/or receiving email; an application for sending and/or receiving text or short message service (SMS) messages; a calendar application; a contact list application; a web browsing application; etc. In particular, the applications 454 may include an application for accessing computing platform 102.

The program memory 415 and/or the RAM 417 may also store a variety of subroutines 452 for accessing specific functions of the device 412. By way of example, and without limitation, the subroutines 452 may include, among other things: a subroutine 452A for accessing geolocation services, a subroutine 452B for accessing image capture services, and other subroutines, for example, implementing software keyboard functionality, interfacing with other hardware in the device. The program memory 415 and/or the RAM 417 may further store data related to the configuration and/or operation of the device 400, and/or related to the operation of one or more of the applications 454 or subroutines 452. For example, the data may be image data captured by an image capture device 266, may be data input by a user, may be data received from a server (e.g., the computing platform 102), data determined and/or calculated by the processor 459, etc.

In addition to the controller, the device 400 may include other hardware resources. For example, the device 400 may include a power supply 458, which may be a battery in the case of a mobile device. The device 400 may also include various types of input/output hardware such as a visual display 460, a keyboard 464, an image capture device 466, one or more speakers 474, a microphone 475, and/or a pointing device (not shown). In an embodiment, the display 460 is touch-sensitive, and may cooperate with a software keyboard routine as one of the software routines 452 to accept user input. The image capture device 466 may be any type of image capture device. In an embodiment in which the computing platform 102 communicates with the smart phone 400, the smart phone 400 may include a built-in image capture device. Alternatively, the image capture device 466 may be, in some instances, external to the device 400, such as coupled to the device 400 via a serial connection (e.g., a universal serial bus, or “USB,” connection). In some embodiments, the image capture device 466 includes adjustable focusing optics. In some embodiments, the image capture device 466 may also include optics for allowing the image capture device 466 to zoom. Neither zooming optics nor focusing optics are required, however. For example, the image capture device 466 may include focusing optics that focus at “infinity”.

Referring still to FIG. 4, the device 400 may be configured with a communication block including a variety of hardware for wireless and/or wired communications. Exemplary wireless communication hardware in the communication block may include cellular telephony circuitry 468, GPS receiver circuitry 476, Bluetooth circuitry 480, Wi-Fi circuitry 482 (i.e., circuitry complying with an IEEE 802.11 standard), as well as hardware supporting any number of other wireless communications protocols. Exemplary wired communications hardware in the communication block may include, for example, USB circuitry 470, Ethernet circuitry 471, and/or hardware supporting any number of other wired communications protocols.

One of the applications 454 or subroutines 452 stored in the program memory 415 of the device 400 may be a location services software routine 452C for determining the geographic location of the device 400 based on inputs from hardware in the communication block. Specifically, the locations services routine 452C may determine the device's geographical location by, for example, receiving data from the GPS receiver circuitry 476, or performing triangulation using signals received from the cellular telephony circuitry 468. The device 400 may also use other methods known in the art for determining its geographic location such as by reference to the names of detected wireless network SSID names or other sensed wireless signals for which the geographic location is known or ascertainable.

It should be recognized that different mobile devices may implement different mechanisms for user input. In an example described above, the device 400 may have a touch sensitive display screen 460. Accordingly, “buttons” which are displayed on the screen and are not physical buttons, are “pressed” by touching the screen in the area of the button. However, those of ordinary skill in the art will readily appreciate that such user interface controls may be accomplished in other manners, such as using soft-keys, navigating controls using navigation buttons on a keyboard or using a roller ball, selecting numbers corresponding to different controls, entering information on a keyboard, etc.

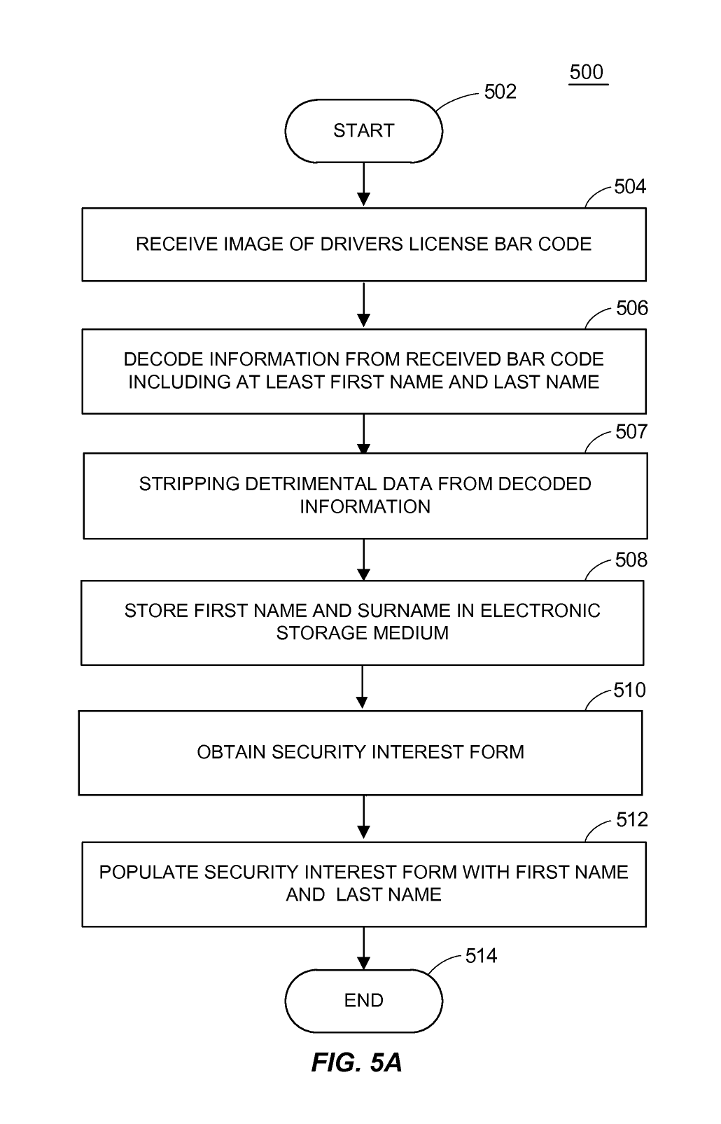

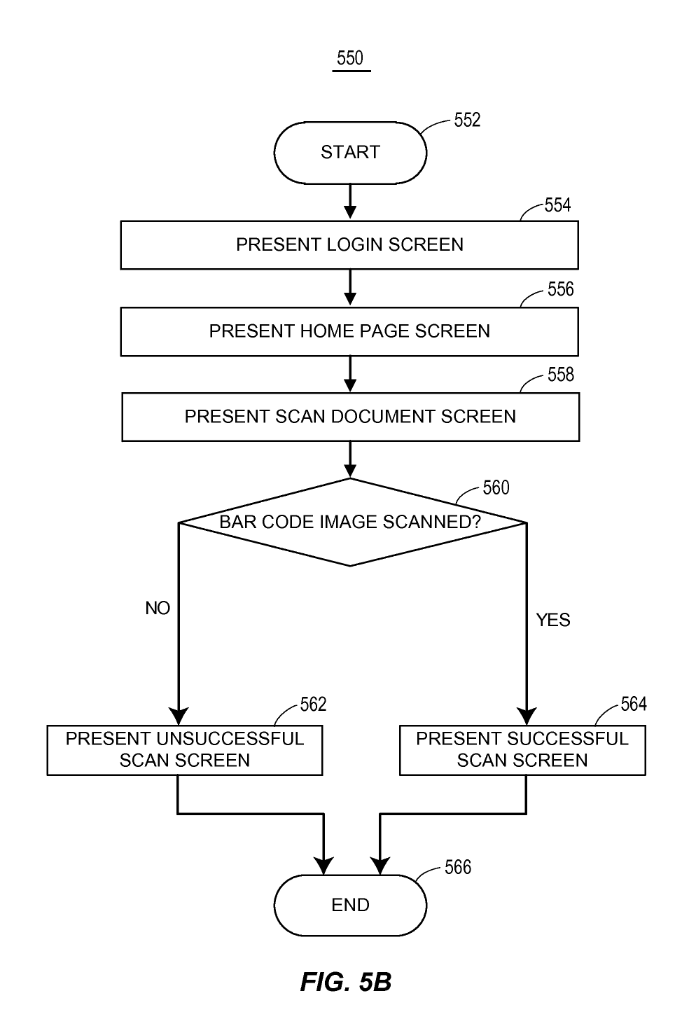

FIG. 5A depicts a flow diagram of an example method 500 consistent with the present invention. In some embodiments, the method 500 includes one or more additional blocks not shown in FIG. 5A. In one embodiment, the method 500 is implemented in (e.g., performed by a processor within) a server device, such as computing platform 102 of FIG. 1, for example.

Method 500 begins at start block 502, and receives an image of a driver's license bar code (block 504). The image may be in any suitable image file format such as PDF, HTML, JPEG, GIF, PNG, or others. In response to receiving an image of a driver's license bar code, the system automatically decodes the information contained therein including at least a first name and last name of the licensed driver (block 506). Any detrimental data is stripped from the decoded data and discarded, i.e., deleted or otherwise disposed of in a secure fashion (block 507). The system may decode the bar code information according to any known method such as use of scanning hardware with a decoding circuit or via a software library including decoding routines for the appropriate bar code format. A software decoding library may be stored on a non-transitory, computer-readable medium on computing platform 102, for example, in image processing module 232 as shown in FIG. 1. At block 508, an embodiment of the invention stores at least the decoded first name and last name in an electronic storage medium such as, for example, database 103. In another embodiment, the invention only temporarily stores the decoded first name and last name in an electronic storage medium. At block 510, an embodiment of the invention obtains a security interest form, financing statement, or other appropriate document suitable for filing with government agency 112. The form may also be obtained from database 103 or from any other digital or physical storage location. At block 512, the system populates the form obtained in block 510 with at least the first name and last name decoded in block 506.

FIG. 5B depicts a flow diagram of an example method 550 consistent with the present invention. In some embodiments, the method 550 includes one or more additional blocks not shown in FIG. 5B. In one embodiment, the method 550 is implemented in (e.g., performed by a processor within) a server device, such as computing platform 102 of FIG. 1, or on a handheld device or computer operated by the debtor, creditor, or other party, for example. Method 550 begins at start block 552 and presents a login screen to the user at block 554. The login screen may require a username, password, pin, or other authentication credentials. Block 556 presents a home page screen to the user that may include, for example, a welcome message, help function, logout function, and scan document function. At block 558 a present scan document screen is presented to the user that may include level and framing brackets and scanning instructions. Decision block 560 determines whether a valid bar code was entered at block 558. If a valid bar code was scanned, then a successful scan screen is presented to the user at block 564. If a valid bar code was not scanned, an unsuccessful scan screen is presented to the user at block 562.

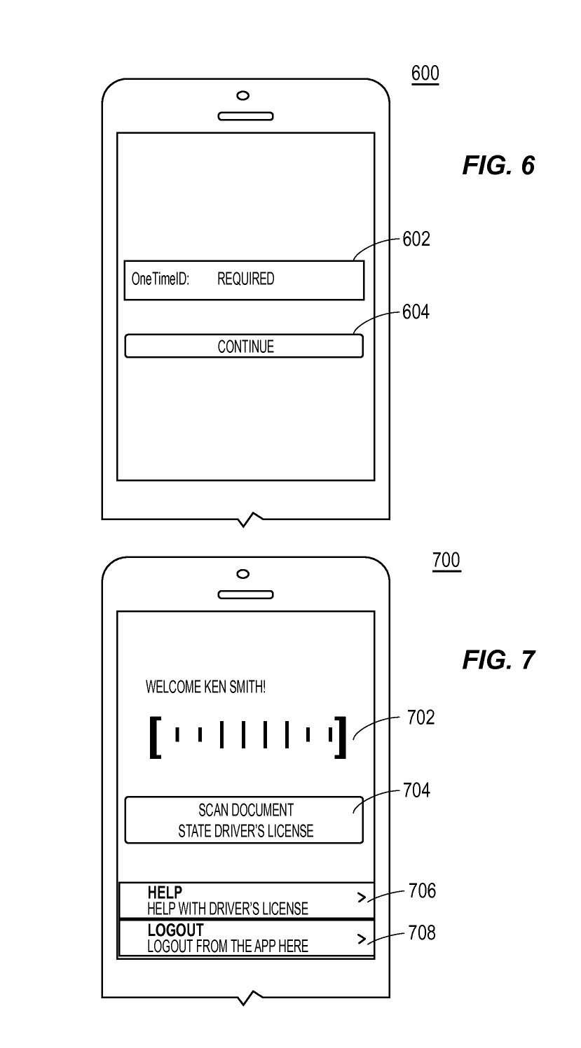

FIG. 6 is a screen shot of an example login screen 600. Login screen 600 may include authentication credential input field 602 for user input of a username, password, PIN number, handle, user ID, or other authentication information, or any combination thereof. Login screen 600 may further display Continue button 604 to submit the entered authentication credential information.

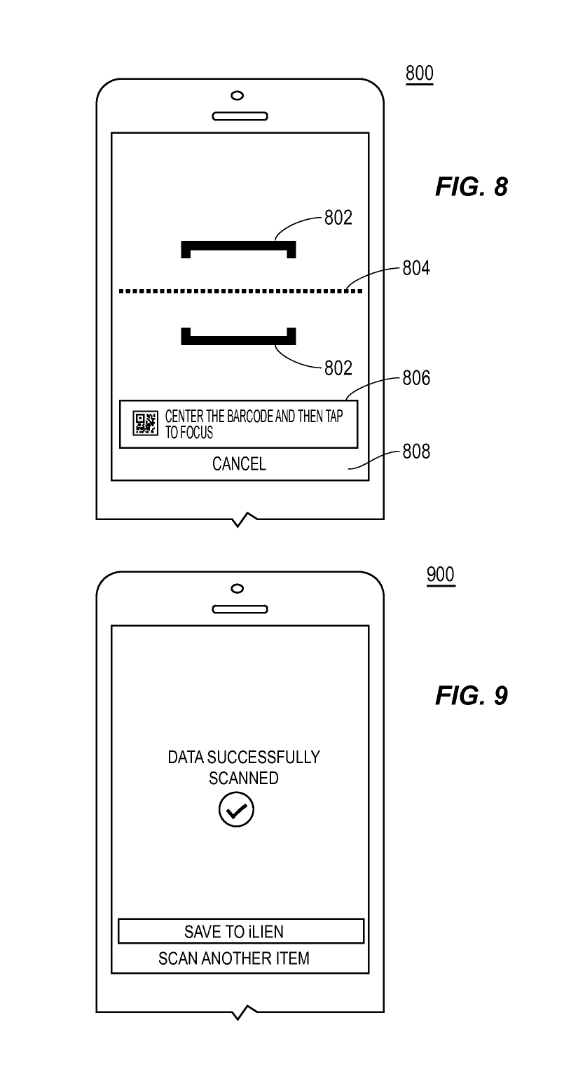

FIG. 7 is a screen shot of a home page screen 700. Home page screen 700 may include centering bracket 702. Home page screen 700 may further include scan document button 704, help button 706, and logout button 708. In an embodiment, scan document button 704 activates an image capture device such as image capture device 240 shown in FIG. 1. Scan document button 704 may alternatively activate a hardware barcode reader such as barcode reader 238 as shown in FIG. 1. Scan document button 704 may also present scan document screen 800 as shown in FIG. 8.

FIG. 8 is a screen shot of a scanning document screen 800. Scanning document screen 800 may present a visual display to the user reflecting the input to activated image capture device 240. Scanning document screen 800 may include image bracketing bars 802, image level reference bar 804, scan button 806, and cancel button 808. Scan button 806 may display scanning instruction to the user as shown in FIG. 8. When the user taps or selects scanning button 806, image capture device 240 captures the selected image, and may pass the captured data to routines such as, for example, image processing module 232, bar scan module 230, or data extraction module 236.

FIG. 9 is screen shot of a successful scan screen 900. Successful scan screen 900 may be displayed after the user has selected scanning button 806. Successful scan screen 900 may indicate that the captured bar code data meets minimum threshold quality and scanability requirements as determined by image processing module 232 or other software routines. Successful scan screen 900 may further indicate a successful decoding of the bar code data by data extraction module 236. In one embodiment, successful scan screen 900 is displayed on a remote handheld device operated by a user such as the debtor, creditor, or other third party wherein only selected information from the scanned bar code is decoded, stored, and/or transmitted such as only the debtor's first name and last name.

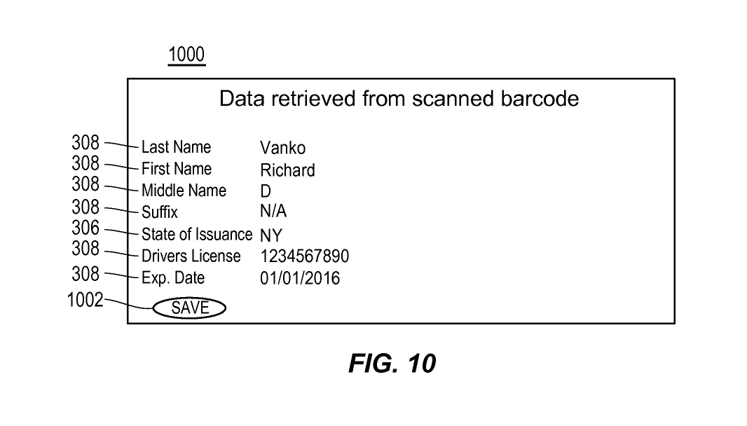

FIG. 10 illustrates an example array 1000 of data decoded from bar code information 242 according to one embodiment of the invention. Decoded data may include personal information fields 308, issuing agency field 306, and any other information printed on, or not printed on, the face of driver's license 260.

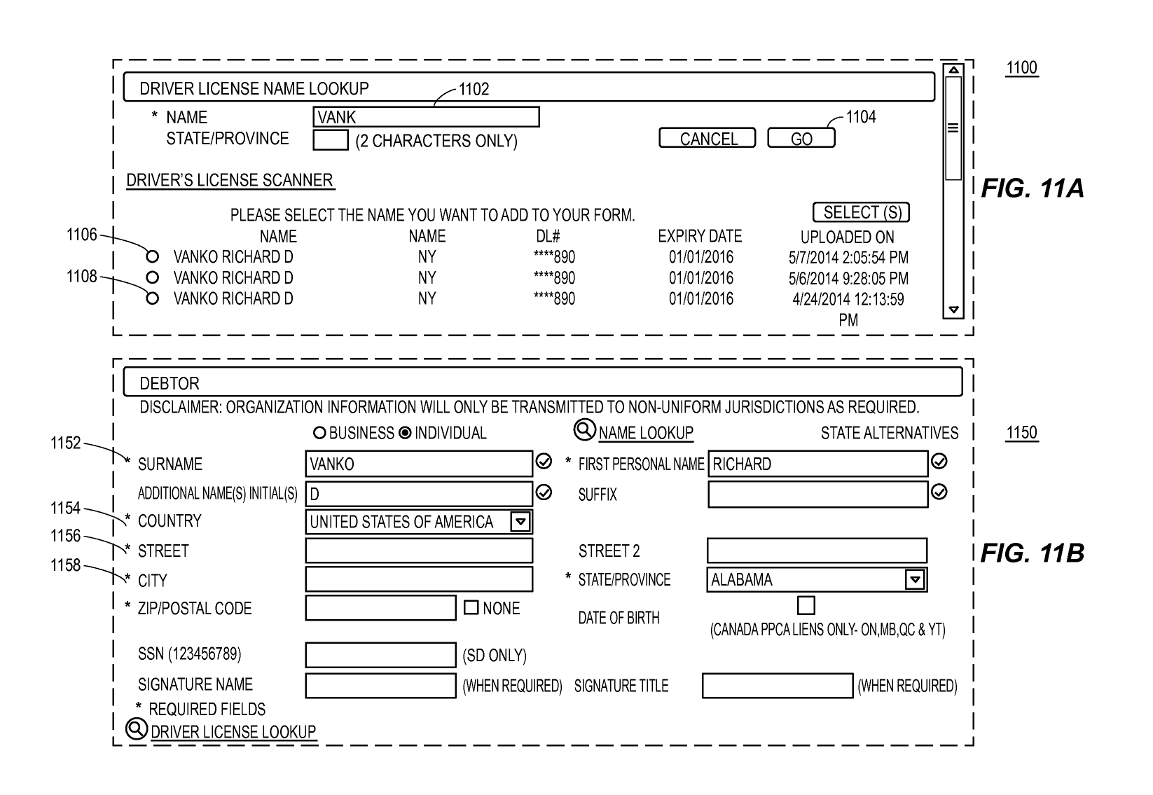

FIGS. 11A and 11B are screen shots of debtor information selection screen 1100 and financing statement population screen 1150, respectively. Debtor information selection screen 1100 and financing statement population screen 1150 may be presented to a user of, for example, computing platform 102, handheld device 400, or any other device in accordance with the invention. Debtor information selection screen 1100 may contain name search field 1102 and Go button 1104. The user may enter any string in name search field 1102 and select Go button 1104 to obtain matching search results such as search results 1106 and 1008. Matching search results 1106 and 1108 display selected information obtained from barcode 242 on driver's license 260 to indicate the availability of that data for population in a security interest form. Financing statement population screen 1150 may contain debtor identify and related information fields such as surname field 1152, country field 1154, Street1 field 1156, and city field 1158. Upon selection of a matching search result such as result 1106, financing statement population screen 1150 may automatically populate the debtor identify and related information fields with the corresponding data. Financing statement population screen 1150 may then submit the populated and entered data to, for example, financing statement population module 234. Which, in turn, may submit the populated and entered data to financing statement filing module 252 for automatic filing with DMV (or state agency) 112 via state agency computing device 113.

It will be appreciated that the above descriptions are provided by way of example and that numerous modifications may be made within context of the present techniques. As referenced above, other types of legal filings are amenable to the techniques of the current invention other than financing statements filed pursuant to Revised Article 9 of the UCC. Other examples include: populating the name field for conducting searches of public records for purposes of the UCC, Patriot Act, tax liens, and judicial judgments; population of a loan application, account creation for the establishment of new accounts such as a bank account; validation of extracted data from a state department of motor vehicles, monitoring of a driver's license expiration date for compliance purposes, and monitoring of extracted data from a state department of motor vehicles for changes to name fields, or expiration date. These are but exemplary illustrations of applications of the current invention, and persons having ordinary skill in this art will appreciate additional applications.

The various blocks, operations, and techniques described above may be implemented in hardware, firmware, software, or any combination of hardware, firmware, and/or software. When implemented in hardware, some or all of the blocks, operations, techniques, etc. may be implemented in, for example, a custom integrated circuit (IC), an application specific integrated circuit (ASIC), a field programmable logic array (FPGA), a programmable logic array (PLA), etc.

When implemented in software, the software may be stored in any computer readable memory such as on a magnetic disk, an optical disk, or other storage medium, in a RAM or ROM or flash memory of a computer, processor, hard disk drive, optical disk drive, tape drive, etc Likewise, the software may be delivered to a user or a system via any known or desired delivery method including, for example, on a computer readable disk or other transportable computer storage mechanism or via communication media. Communication media typically embodies computer readable instructions, data structures, program modules or other data in a modulated data signal such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Thus, the software may be delivered to a user or a system via a communication channel such as a telephone line, a DSL line, a cable television line, a wireless communication channel, the Internet, etc. (which are viewed as being the same as or interchangeable with providing such software via a transportable storage medium).

Moreover, while the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

Thus, although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1. A method for validating individual debtor information to perfect a creditor's security interest, the method comprising:
receiving, by an electronic circuit, a digital image of an individual debtor's government-issued identification document, wherein the digital image contains at least one bar code;
decoding the at least one bar code, by the electronic circuit, to retrieve information about the individual debtor from the at least one bar code, said information including at least an exact name of the individual debtor;
stripping from said information about the individual debtor fields that are the debtor's race, gender, able-bodied status, age, national origin, sexual orientation, religion, criminal history, or social security number;
storing the exact name of the individual debtor in an electronic storage medium without storing or collecting the debtor's race, gender, able-bodied status, age, national origin, sexual orientation, religion, criminal history, or social security number;
obtaining a security interest form from a source location, said security interest form having at least fields for the exact name of the individual debtor;
populating the name fields of the security interest form with the individual debtor's exact name; and
outputting the security interest form containing at least the populated name fields.

2. The method of claim 1, the method further comprising wherein the bar code is a PDF417 bar code.

3. The method of claim 1, the method further comprising decoding name title information for the individual debtor from the at least one bar code.

4. The method of claim 1, the method further comprising decoding name suffix information for the individual debtor from the at least one bar code.

5. The method of claim 1, the method further comprising decoding a driver's license serial number for the individual debtor from the at least one bar code.

6. The method of claim 1, the method further comprising decoding a middle name for the individual debtor from the at least one bar code.

7. The method of claim 1, the method further comprising decoding an issuing government for the individual debtor from the at least one bar code.

8. The method of claim 1, the method further comprising wherein the electronic storage medium is a cloud storage medium.

9. The method of claim 1, wherein the security interest form is a form pursuant to Article 9 of the Uniform Commercial Code.

10. The method of claim 1, further comprising locking the exact name fields on the form.

11. The method of claim 1, the method further comprising decoding an identification document expiration date for the individual debtor from the at least one bar code.

12. The method of claim 1, the method further comprising indicating on the electronic storage medium that the exact name was obtained from the individual debtor's government-issued identification document.

13. The method of claim 12, the method further comprising indicating that the individual debtor's government-issued identification document was unexpired at the time the information about the individual debtor was obtained.

14. The method of claim 12, the method further comprising wherein the indication is a check mark.

15. The method of claim 1, wherein the government-issued identification document is selected from the group consisting of: a driver's license, a state identification card, and a passport.

16. The method of claim 1, the method further comprising detecting a barcode type at an input device.

17. The method of claim 16, the method further comprising transferring the barcode type to a barcode decoding module.

18. A system for validating individual debtor information to perfect a creditor's security interest, the system comprising:
a communications network interface;
one or more computer processors;
one or more memories coupled to the one or more processors;
wherein the one or more memories include computer executable instructions stored thereon that, when executed by the one or more processors, cause the one or more processors to:
receive an image via the communications network interface of an individual debtor's government-issued identification document, wherein the image contains at least one bar code;
decode the at least one bar code to retrieve information about the individual debtor from the at least one bar code, said information including at least an exact name of the individual debtor;
strip from said information about the individual debtor fields that are the debtor's race, gender, able-bodied status, age, national origin, sexual orientation, religion, criminal history, or social security number;
store the exact name of the individual debtor in an electronic storage medium without storing or collecting the debtor's race, gender, able-bodied status, age, national origin, sexual orientation, religion, criminal history, or social security;
obtain a security interest form from a source location, said security interest form having at least fields for the exact name of the individual debtor;
populate the name fields of the security interest form with the individual debtor's exact name; and
output the security interest form containing at least the populated name fields.

19. The system of claim 18, further comprising a scanner for scanning the image of an individual debtor's government-issued identification document.

20. A method for validating individual debtor information to perfect a creditor's security interest, the method comprising:
receiving, by an electronic circuit, an name from an individual debtor exactly as it appears on a government-issued identification document;
storing the exact name of the individual debtor in an electronic storage medium without storing or collecting the debtor's race, gender, able-bodied status, age, national origin, sexual orientation, criminal history, or social security number;
obtaining a security interest form from a source location, said security interest form having at least fields for the name of the individual debtor;
populating the name fields of the security interest form with the individual debtor's exact name;
outputting the security interest form containing at least the populated name fields; and
wherein the debtor's race, gender, able-bodied status, age, national origin, sexual orientation, religion, criminal history, or social security number was stripped from information decoded from a barcode on a government-issued identification document.
